(19) United States
(12) Patent Application Publication
(10) Pub. No.: US 2001/0034562 A1
(43) Pub. Date: Oct. 25, 2001

(54) Editor for creating process plans

(76) Inventors: Richard Aumer, Weixdorf (DE); Bernd Irsch, Schuabach (DE); Klaus Schmalzbauer, Pettendorf (DE); Winfried Zedlacher, St. Veit/Glan (AT); Wolfgang Groger, Dresden (DE); Martin Neumayer, Elsendorf (DE); Winfried Schneider, Munchen (DE)

Correspondence Address: LERNER AND GREENBERG, P.A., POST OFFICE BOX 2480, HOLLYWOOD, FL, 33022-2480, US

(21) Appl. No.: 09/803,761

(22) Filed: Mar. 12, 2001

(30) Foreign Application Priority Data
Mar. 10, 2000 (EP) 00250090.8

(51) Int. Cl. G06F 19/00

(52) U.S. Cl. 700/97; 700/103; 700/104; 700/105; 707/104.1

(57) ABSTRACT

The invention relates to an editor (1) for creating process plans, having storage means (2) for storing various process objectives, having storage means (3) for storing rules for the forming of process plans by linking process objectives via process planning steps and/or branches, having indicating means for indicating process objectives, process planning steps, branches and process plans and having checking means (9) for checking process plans, it being possible, dependent on the check, for a release message to be activated.

The invention relates to an editor for creating process plans. Process plans of this type serve as a basis for manufacturing products.

In the manufacture of products, for example in the areas of motor vehicle construction and the construction of machines and installations, the manufacture of products is performed by means of production processes based on parts lists.

The products, such as motor vehicles, machines or installations for example, represent complex units, which in each case comprise a predetermined number of functional units, which in turn comprise a hierarchical structure of components, with finally, on the lowest hierarchical level, a component comprising a certain number of individual parts, such as turned or milled parts for example.

Parts lists exist in each case for the individual units, functional units, components and individual parts, altogether forming a hierarchical system of parts lists.

The management of such parts lists is performed by means of commercial software systems, such as PDM (Product Data Management) software systems for example.

On the basis of such software systems, a largely automated production of such products takes place. The production of such products is performed for example by means of CIM (Computer Integrated Manufacture) concepts.

In the area of the pharmaceutical industry, the chemical industry and, in particular, in the area of the semiconductor industry, a process-based manufacture of products takes place. Accordingly, production methods based on parts lists cannot be used in these areas, and consequently nor can the automated production methods based on them.

For example, in the semiconductor industry, a large number of production and measuring processes are required in the processing of wafers. These include in particular lithography processes, etching processes, diffusion processes, depositing and implanting processes and also various measuring processes for monitoring these production processes.

The individual production and measuring processes are admittedly carried out in a partly automated manner in corresponding production and measuring units. However, there is no automated production sequence in which the production and measuring steps carried out in the individual production and measuring units are linked. Therefore, to record the entire production sequence, the data of individual production units and measuring units must be compiled manually. Apart from technical and product-dependent specifications, these data are in particular logistical and business-management data.

This does not just lead to more difficult monitoring of the production sequence. A major problem is also that there is no adequate planning certainty in the creation of such a production sequence or modification of it. In particular, the necessary transparency is lacking when individual production and measuring steps are combined to form a production sequence, so that there is an undesirably high risk of error in the definition of such production sequences.

The invention is based on the object of providing a device by means of which process-based production sequences can be defined with high planning certainty and low risk of error.

The features of claim 1 are provided to achieve this object. Advantageous embodiments and expedient developments of the invention are described in the subclaims.

According to the invention, for creating process plans, an editor is provided, having storage means for storing various process objectives and storage means for storing rules for the forming of process plans by linking process objectives via process planning steps and/or branches. Moreover, indicating means for indicating process objectives, process planning steps, branches and process plans are provided. Finally, checking means for checking process plans are provided, it being possible, dependent on the check, for a release message to be activated.

The basic idea of the invention is that, by means of the editor according to the invention, which is installed on a computer unit, a user can create a process plan for the sequence of a complete production process or part of such a production process. This involves the process objectives required for such production processes being stored in the editor in the form of a library.

Such process objectives represent in particular predetermined production or measuring steps which are required in a process-based production sequence. For example, such a process plan can be used for the processing of wafers in a semiconductor production plant. The individual process objectives in this case define for example the result to be achieved by an etching process, a photolithographic process or the like.

Moreover, the process objectives may consist in the specification of target values of measuring processes for the monitoring of individual production steps. The process objectives themselves are defined in the form of sets of parameters which describe the results or specifications to be achieved in the individual production or measuring steps.

The individual process objectives are linked by the user via process planning steps and/or branches, so that a logical sequence in which the individual process objectives are executed is obtained.

In the editor, rules for the forming of linkages are stored. By means of the checking means, which are provided in the editor, the process plan created by the user is automatically checked. In particular, it is checked on the basis of the stored rules whether the linkages of individual process objectives are being properly carried out. Advantageously, consistency checks of a created process plan are also carried out by means of the checking means. Finally, individual process objectives also have release and status parameters, which are checked by the checking means.

Dependent on the checking carried out by the checking means, a release message can be activated. A valid process plan which can be used for the production of products only exists when such a release message is present.

The release message expediently occurs only when the linkages carried out in the process plan are carried out in accordance with the rules stored in the editor, when the consistency checking in the editor has been successfully carried out and when the release and status parameters of the process objectives correspond to predetermined setpoint values.

By means of the editor according to the invention, a database which allows process plans to be created in a complete and reproducible manner is thus provided, thereby achieving high planning certainty in the devising of process-based production sequences.

A major advantage is that automatic monitoring of the process plans is performed by means of the checking means in the editor. The editor consequently forms a monitoring and controlling means, which considerably increases the immunity to errors in production planning.

It is particularly advantageous that the process plans created by means of the editor are independent of a particular product to be produced and also independent of the specific production and measuring units which are being used for manufacturing such products.

The individual process plans can consequently be used for example for different products of the same technology.

Reference of the process plan to specific production and measuring units of a production plant is preferably made possible by an assignment of individual-process instructions to the respective process objective in the process plan. The individual-process instructions are determined in each case by a specific set of parameters, by means of which the reference to the respective production and measuring unit takes place and the production parameters are defined.

Finally, the process plans may be assigned product work plans, by means of which the reference of a process plan to a specific product takes place. The product work plans are also determined by sets of parameters, these establishing the reference to the respective product.

The assignments existing between the process plans, the process planning steps, the process objectives, the individual-process instructions and the product work plans allow these individual components to be used repeatedly, and consequently extremely flexibly, in the editor. In particular, process objectives and individual-process instructions can be used for various process plans.

The invention is explained below with reference to the drawings, in which:

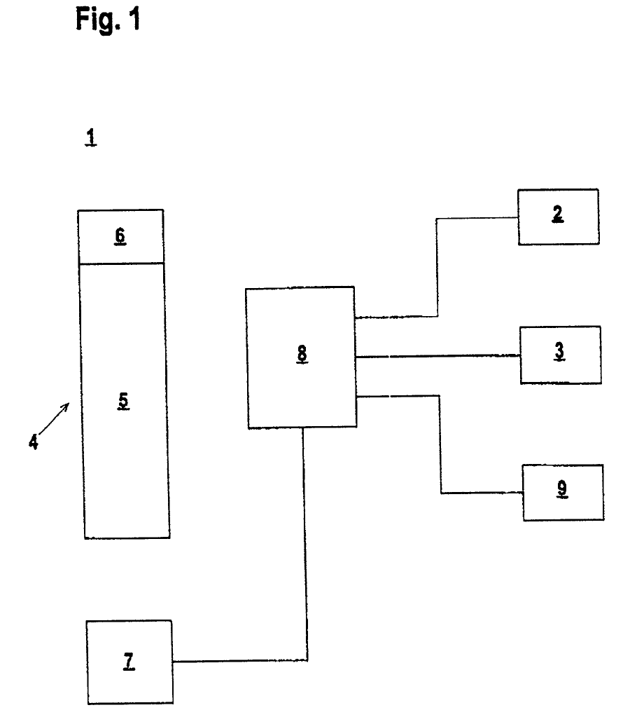

FIG. 1 shows a block diagram of an exemplary embodiment of an editor for the creation of process plans.

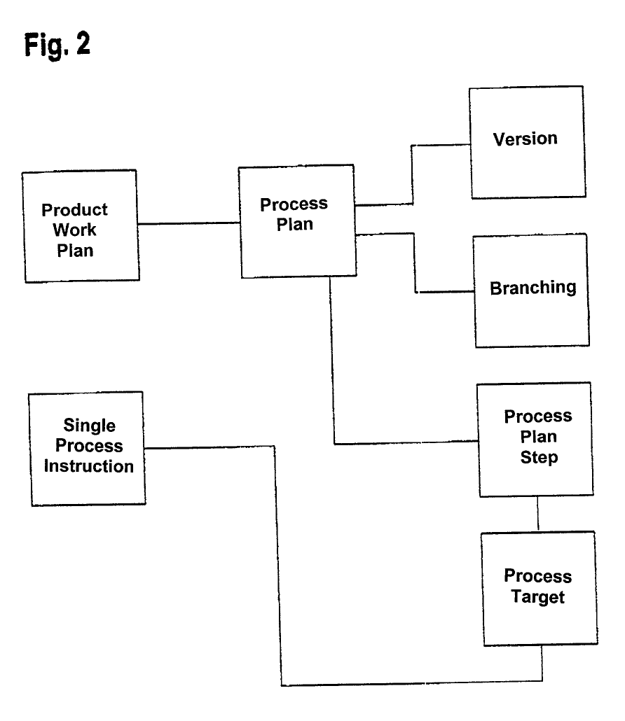

FIG. 2 shows a block diagram of elements for the creation of process plans.

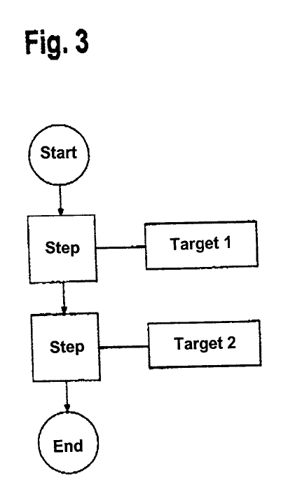

FIG. 3 shows a first exemplary embodiment of a process plan structure.

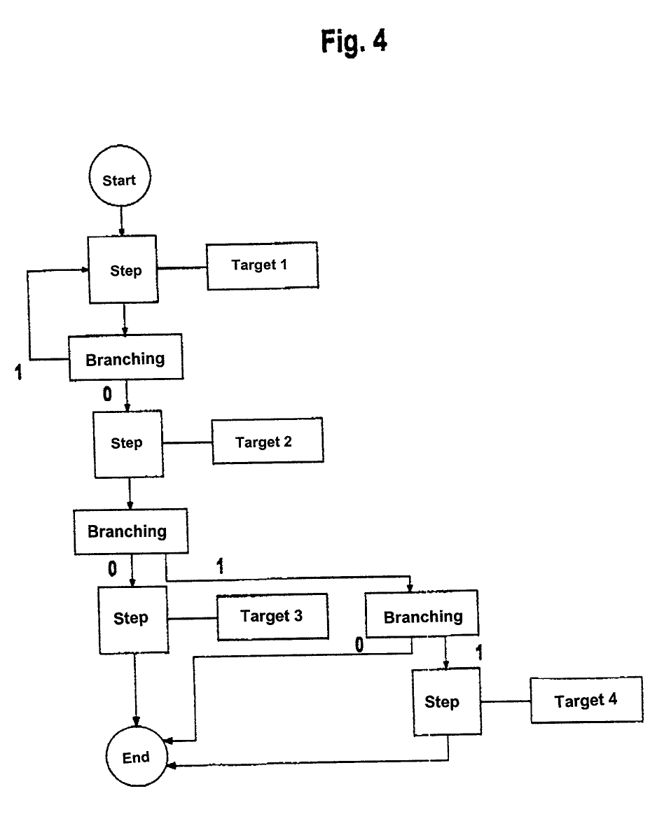

FIG. 4 shows a second exemplary embodiment of a process plan structure.

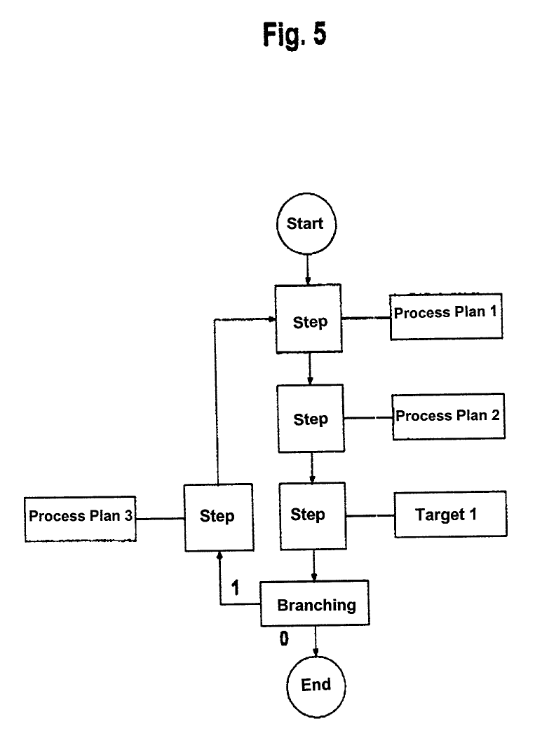

FIG. 5 shows a third exemplary embodiment of a process plan structure.

FIG. 1 shows a block diagram of an exemplary embodiment of an editor 1 for the creation of process plans. Such process plans describe the production sequence in the manufacture of products, these production sequences being process-based production sequences. Such process-based production sequences are to be found for example in the chemical or pharmaceutical industry or in the semiconductor industry.

In the present exemplary embodiment, the process plans serve for the processing of wafers, for example for the manufacture of integrated circuits such as DRAMs or the like.

The editor 1 constitutes part of a computer unit (not represented), such as a personal computer for example. By means of this editor 1, process plans can be created by a user by combining individual elements. These elements are formed by process objectives, which are interlinked via process planning steps and/or branches.

The editor 1 has first storage means 2, in which a number of different process objectives are stored in the form of a library.

Furthermore, the editor 1 has second storage means 3, in which rules for the linking of process objectives via process planning steps and/or branches are stored.

In principle, instead of separate storage means 2, 3, a common storage means may also be provided. The storage means 2, 3 may be formed by volatile or non-volatile memories.

Furthermore, the editor 1 has indicating means, which serve for indicating process plans, process objectives, process planning steps and branches. The indicating means preferably constitute part of a graphical interface 4, which is represented on a terminal (not represented) of the computer unit.

The graphical interface 4 is in this case expediently divided into different segments 5, 6. In a first segment 5, the structures of the process plans entered by the user via an input unit 7 are visually displayed. The input unit 7 is formed by a keyboard and/or a mouse.

Apart from the first segment 5, the graphical interface 4 has a second segment 6, in which the individual elements available for creating the process plans, in particular the individual process objectives, process planning steps and branches, are indicated to the user. This segment 6 is preferably divided into corresponding subsegments, which in each case serve for indicating one element type.

The storage means 2, 3, the indicating means and the input unit 7 are connected to a control unit 8, which controls the operation of the editor 1. The control unit 8 is formed for example by a microprocessor or the like, which is integrated in the computer unit.

Moreover, checking means 9, which are formed by a separate microprocessor or the like, are connected to the control unit 8. Alternatively, the checking means 9 may also be integrated in the microprocessor forming the control unit 8.

By means of the checking means 9, a process plan created by a user is automatically checked. In particular, it is checked whether the process plan was created in accordance with the stored rules. Furthermore, a consistency check of the process plan is performed. In this check, it is checked in particular whether the individual process objectives have been linked to form a process plan which is complete and can be implemented. Finally, predetermined release and status parameters may be defined for the individual process objectives and are stored with the process objectives. These parameters are checked by the checking means 9 to ascertain whether the assigned process objectives can be used in a process plan.

Dependent on the results of the check, a signal is generated by the checking means 9 and is read into the control unit 8. In the simplest case, this signal is formed by a binary signal. If checking is successful, when the signal is read into the control unit 8 a release message is generated, indicating error-free creation of a process plan or part of a process plan. In the case of an unsuccessful check, an error message occurs and/or a blocking signal is output, by means of which the release of a process plan is prevented.

In the simplest case, the check takes place after the user has created a complete process plan. Alternatively, it may be interactively indicated to the user during the creation of the process plan whether or not the linkages created by him are permissible.

FIG. 2 shows a block diagram with various elements for creating a process plan. Apart from the individual process objectives, process planning steps and branches, individual-process instructions and product work plans are also provided as further elements.

The individual process objectives form individual production steps or measuring steps which are to be carried out within a production sequence.

In the processing of wafers, typical examples of such process objectives are:

The vapor-depositing of a layer on a surface. Examples of process parameters which may be defined here are the layer thickness, the nature of the material of the layer and also physical boundary parameters during the vapor-deposition.

These process parameters form a set of parameters for characterizing the process objective.

In an etching process, the etching away of a particular layer thickness may be defined as a process objective.

In a measuring process, the process objective may be determined by a presetting for the measurement of a layer thickness.

The individual process objectives are connected in particular via process planning steps. This results in particular in a time sequence in which the individual process objectives are processed.

The process planning steps consequently form logistical elements, which define in particular the material flow during a production sequence.

A process planning step is used to interconnect in each case two process steps within a process plan. A process plan made up of process objectives and process planning steps consequently leads to linear linking of process objectives, which are sequentially executed.

Alternatively or additionally, a plurality of process objectives may be linked within a process plan via branches. A branch is used for linking a process objective not just to one process objective but to at least two further process objectives. Alternatively, a branch may lead to a further branch, so that a nested structure of a plurality of branches is obtained as a result.

The individual branches may contain conditions, dependent on which at least one limb of the branch can be selected in the execution of the individual process objectives.

In an advantageous embodiment, further process plans can be called up via process planning steps or branches within a process plan. Consequently, a process plan may be constructed not only from a number of process objectives but also from a number of further process plans.

A process plan constructed from individual process objectives, process planning steps, branches and possibly further process plans defines a production sequence which is independent of the use of particular production or measuring units and independent of a particular product. Consequently, the process plan can be used for different products of the same technology.

In the present exemplary embodiment, the process plans serve for describing production sequences in the processing of wafers. A plant- and product-independent process plan may in this case comprise the processing of wafers of the same technology or different types. For instance, the processing of both test wafers and various customized wafers can be described by a process plan. Furthermore, such a process plan defines the production sequence independently of the production plant.

As can be seen from FIG. 2, the process objectives may be assigned individual-process instructions. Individual-process instructions are determined by a set of parameters which is specific for a plant, namely a production unit or measuring unit.

An assignment of one or more individual-process instructions to a process objective preferably takes place independently of the use of a process objective in process plans. Consequently, it is established on which production or measuring units the respective process objective can be achieved.

If, for example, the process objective consists in applying a layer to the surface of a substrate, the type of production unit with which the application of the layer is performed is established by assignment of the individual-process instruction to the process objective. Furthermore, the typical plant parameters of the production plant which are necessary for achieving the process objective are preferably defined.

By the assignment of an individual-process instruction to a process objective, consequently the type and nature of the production or measuring unit with which the process objective is to be achieved is established.

In this case, the process objectives and the process plans put together from them are still independent of the specific product which is being manufactured with the process plan. A particular product type is only established when product work plans are assigned to the process plans. These product work plans are created by assigning product-specific sets of parameters to the respective process plans.

For example, test wafers or customized wafers are defined as products by these sets of parameters. Depending on the form taken by these sets of parameters, the assignment establishes whether test wafers or particular customized wafers are processed with a process plan.

Finally, the process plan is assigned version numbers. This is indicated in FIG. 2 by “version”. These version numbers allow the checking means 9 to carry out version management, recording in particular the sequence of modifications to the process plans.

The individual elements, in particular the process objectives, individual-process instructions and product work plans, are in this case expediently assigned status parameters, which in each case include a version number and possibly further information on the type and extent of the modifications to the respective element. Moreover, these elements are assigned release parameters, on the basis of which it can be checked by the checking means 9 whether the individual elements may be used for the creation of process plans.

Different examples of process plans are represented in FIGS. 3-5. Each process plan begins with a start element and ends with an end element, which represent special forms of process planning steps.

Represented in FIG. 3 is a linear structure of a process plan. This process plan contains only two process planning steps (step) arranged one behind the other, which lead in each case to a process objective to be executed, objective 1, objective 2.

The time sequence of the process objectives is fixed by the process planning steps.

FIG. 4 shows an exemplary embodiment of a process plan with a plurality of process planning steps and branches. Firstly, a first process planning step leads to a first process objective, objective 1.

The first process planning step is followed by a first branch, in which a condition is stored. If the condition is not satisfied, a logical variable, as represented in FIG. 4, is set to the value 1, so that a return to the first process planning step takes place, whereupon the process objective, objective 1, is executed once again. If the condition is satisfied, the logical variable is set to the value 0 in the branch, so that the execution of the second process objective, objective 2, takes place via a downstream process planning step.

The second process planning step is followed by a second branch, in which a condition is likewise stored. If the condition is satisfied, a logical variable is set to the value 0, so that the process objective, objective 3, is executed in a limb of the process plan via a further process planning step, whereupon the end of the process plan is reached.

If the condition is not satisfied, a further limb of the process plan leads to a further branch, in which in turn a condition is stored. If the condition is satisfied, the end of the process plan is reached, whereas, if the condition is not satisfied, a further process objective, objective 4, is executed via a further process planning step before the end of the process plan is reached.

In the case of the process plan represented in FIG. 5, three process planning steps are run through one after the other after the start of the process plan. Further process plans 1 and 2 are executed in each case via the first and second process planning steps, while a process objective, objective 1, is executed via the third process planning step.

The third process planning step is followed by a branch. If the condition is satisfied, the end of the process plan is reached, whereas, if the condition is not satisfied, the execution of a further process plan 3 takes place via a further process planning step and then a return is made to the first process planning step, whereupon the process plan 1 is executed once again.

1. An editor (1) for creating process plans, having storage means (2) for storing various process objectives, having storage means (3) for storing rules for the forming of process plans by linking process objectives via process planning steps and/or branches, having indicating means for indicating process objectives, process planning steps, branches and process plans and having checking means (9) for checking process plans, it being possible, dependent on the check, for a release message to be activated.

2. The editor as claimed in claim 1, characterized in that the sequence in which process objectives are processed is predetermined by linking process objectives via process planning steps and/or branches.

3. The editor as claimed in either of claims 1 and 2, characterized in that a plurality of process plans are linked via process planning steps and/or branches.

4. The editor as claimed in one of claims 1-3, characterized in that each process planning step respectively leads just to one process objective or one process plan.

5. The editor as claimed in one of claims 1-4, characterized in that each branch is led to process planning steps and/or further branches.

6. The editor as claimed in claim 5, characterized in that the branches contain conditions, dependent on which at least one limb of the branch can be selected.

7. The editor as claimed in one of claims 1-6, characterized in that the process objectives form production steps or measuring steps of a production process.

8. The editor as claimed in one of claims 1-7, characterized in that the process objectives are in each case characterized by a set of parameters.

9. The editor as claimed in claim 8, characterized in that the sets of parameters of the process objectives are product-independent and plant-independent.

10. The editor as claimed in one of claims 7-9, characterized in that a process objective in a released process plan is assigned at least one individual-process instruction.

11. The editor as claimed in claim 10, characterized in that each individual-process instruction is determined by a set of parameters which is specific for a plant on which the measuring or production step forming the associated process objective is being carried out.

12. The editor as claimed in either of claims 10 and 11, characterized in that a process plan is assigned a product work plan, whereby the process plan is assigned a set of parameters which is specific for the product to be manufactured.

13. The editor as claimed in one of claims 8-12, characterized in that the process plans can be applied to different products of the same technology.

14. The editor as claimed in claim 13, characterized in that the different products of the same technology are formed by different customized products, test products and/or plant-internal products.

15. The editor as claimed in one of claims 1-14, characterized in that the individual process objectives have release and status parameters which can be checked by the checking means (9).

16. The editor as claimed in one of claims 10-15, characterized in that the individual individual-process instructions and product work plans have release and status parameters which can be checked by the checking means (9).

17. The editor as claimed in one of claims 1-16, characterized in that rules are prescribed for the linking of process objectives, process planning steps and branches, compliance with which rules is monitored by means of the checking means (9).

18. The editor as claimed in one of claims 1-17, characterized in that consistency checks are carried out in a process plan by means of the checking means (9).

19. The editor as claimed in one of claims 1-18, characterized in that the indicating means comprise a graphical interface (4) of a computer unit.

20. The editor as claimed in claim 19, characterized in that a process plan created by a user is visually displayed by means of the graphical interface (4).

21. The editor as claimed in claim 20, characterized in that the process objectives and process planning steps available for creating a process plan can be visually displayed by means of the graphical interface (4).

22. The editor as claimed in claim 21, characterized in that only the process objectives and process planning steps released by the checking means (9) can be selected from the available process objectives and process planning steps for creating the process plan.

23. The editor as claimed in one of claims 1-22, characterized in that the process plans created with it are used for the manufacture of semiconductor products, chemical products or pharmaceutical products.

24. The editor as claimed in claim 23, characterized in that the process plans are used for the processing of wafers.
